(19) United States
(12) Patent Application Publication
(10) Pub. No.: US 2004/0141544 A1
(43) Pub. Date: Jul. 22, 2004

(54) Filament temperature measuring device with fluid velocity and temperature compensator system

(76) Inventors: Sam Paris, Chicago, IL (US); Jagdish T. Madhav, Morton Grove, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/734,777

(22) Filed: Dec. 11, 2003

Related U.S. Application Data
(60) Provisional application No. 60/432,579, filed on Dec. 11, 2002.

(51) Int. Cl. G01K 1/16; G01K 1/00; G01K 1/08

(52) U.S. Cl. 374/208; 374/120; 374/141

(57) ABSTRACT

A temperature measuring device having a baffle for measuring the temperature of a moving filament is disclosed. The temperature measuring device includes a body having an inlet and an outlet for entry and exit of the moving filament. The baffle precedes the inlet, and includes at least one fin and at least one aperture adapted to reduce a fluid film associated with the moving filament.

### RELATED APPLICATION DATA

The present application is a non-provisional application based on, and claiming the priority benefit of, co-pending U.S. provisional application Serial No. 60/432,579, which was filed on Dec. 11, 2002, and is expressly incorporated by reference herein.

### FIELD OF THE DISCLOSURE

The disclosure relates to a method and device for measuring the temperature of a moving filament, and more particularly, relates to a method and device for measuring the temperature of a moving filament, having a compensation system for the effects of the velocity and temperature of a fluid film associated with the moving filament.

### BACKGROUND OF THE DISCLOSURE

Temperature measuring devices for measuring the temperature of moving filaments are known in the industry and have a wide range of applicable uses. For example, the type of filament that can be measured may include but, is not limited to, wire, fiber optic cable, film, or any other type of relatively thin or slender natural or synthetic material. The reasons for measuring such filament can vary depending on the material comprising the filament. For example, to ensure that a metal wire has been heated to an appropriate temperature to ensure proper annealing, the user may require the temperature of a wire after an annealing process. Similarly, the user may require the temperature of a wire prior to or after the wire is sheathed with insulation to ensure a proper manufacturing process or adhesion of the insulation.

The types of temperature measuring devices used to obtain the temperature of the filament have evolved over time. Measuring the temperature of a moving wire can now be accomplished by non-contact means between the temperature sensor and the filament. One such non-contact means includes using one or more temperature flow sensors to measure a temperature gradient between the filament and one or more reference bodies. In a most basic explanation, the temperature of the filament in such a process is obtained as the filament moves past a heat flow sensitive surface of the one or more reference bodies. Heat will be exchanged by convection between the filament and the one or more reference bodies whenever they are not at the same temperature. This will cause heat to flow into or out of the heat sensitive surface of the one or more reference bodies. The magnitude of the heat flow will be proportional to the temperature difference between the one or more reference bodies and the filament. Using this temperature difference and other constants, the temperature of the moving filament can be calculated.

In measuring the temperature of a moving filament, temperature sensing devices, including the one described above, have inherent problems to overcome. One such problem involves a fluid film that is dragged into the temperature sensing device by the moving filament. For example, as the filament is moving through the temperature sensing device, any fluid, e.g. air, that enters into the area at which the temperature sensing occurs may cause an inaccurate temperature reading of the filament. This phenomenon increases as the speed of the filament increases due to the greater amount of fluid that can enter into the temperature sensing device. Similarly, the greater the difference between temperature of the fluid, the filament, and the one or more reference bodies, the greater the inaccuracy of the filament temperature measurement.

### SUMMARY OF THE DISCLOSURE

There remains a need for an improved temperature measuring device for measuring the temperature of a moving filament.

In accordance with one aspect of the disclosure, a temperature measuring device having a baffle, for measuring the temperature of a moving filament is provided. The temperature measuring device includes a body having an inlet and an outlet for entry and exit of the moving filament, and the baffle that precedes the inlet. The baffle includes at least one fin and at least one aperture adapted to reduce a fluid film associated with the moving filament.

In accordance with another aspect of the disclosure, a baffle for use with a temperature measuring device for measuring the temperature of a moving filament is provided. The baffle has an inlet and an outlet for entry and exit of the moving filament, and a bore disposed between the inlet and the outlet for receiving the moving filament. The baffle further includes at least one fin disposed along the bore that is oriented generally perpendicular to the bore, and at least one aperture disposed along the bore, that is oriented generally perpendicular to the bore.

In accordance with another aspect of the disclosure, a method of measuring the temperature of a moving filament is provided. The method includes moving the filament through a baffle having at least one fin and at least one aperture, and reducing a fluid film associated with the moving filament. The method further includes moving the filament through a temperature measuring device having a body including an inlet and an outlet for entry and exit of the moving filament, and measuring the temperature of the moving filament with the temperature measuring device.

### BRIEF DESCRIPTION OF THE DRAWINGS

FIG. 1 is a top isometric view of one exemplary embodiment of a filament temperature measuring device as constructed in accordance with the teachings of the disclosure;

FIG. 2 is a bottom isometric view of the filament temperature measuring device of FIG. 1;

FIG. 3 is an isometric view of the baffle in FIG. 1, but depicted in an inverted position;

FIG. 4 is an isometric view of an alternate embodiment of a baffle;

FIG. 5 is an isometric view of another alternate embodiment of a baffle;

FIG. 6 is a front plan view of another exemplary embodiment of a filament temperature measuring device with a closed lid, as constructed in accordance with the teachings of the disclosure; and

FIG. 7 is an isometric view of the filament temperature measuring device of FIG. 6 with an open lid.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the disclosure as defined by the appended claims.

### DETAILED DESCRIPTION

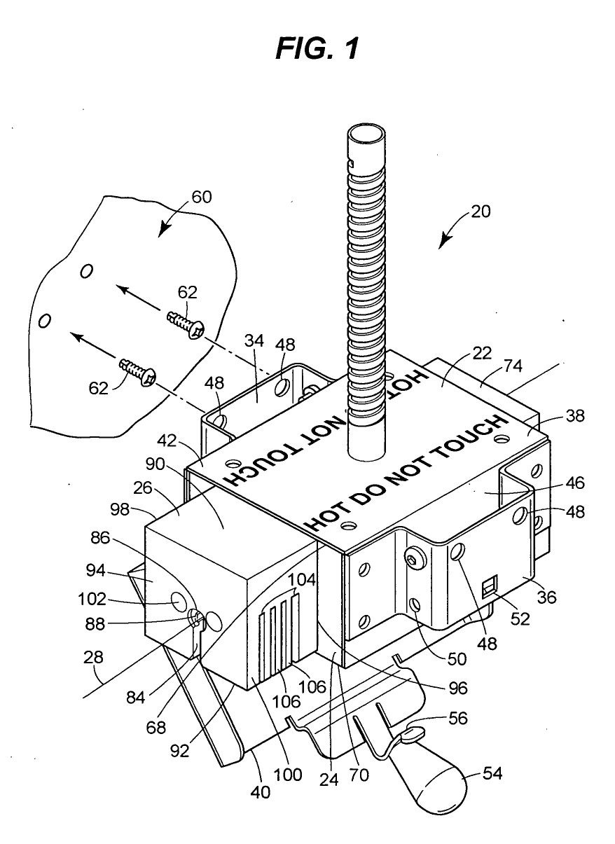

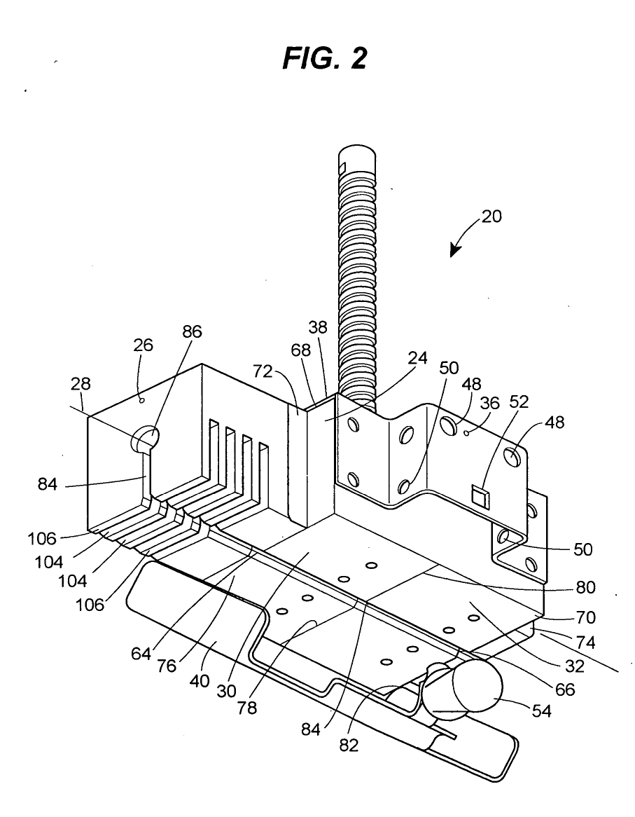

Referring now to the drawings, and with specific reference to FIGS. 1 and 2, one exemplary embodiment of a moving filament temperature measuring device is generally depicted by reference numeral 20. As shown therein, the temperature measuring device 20 includes a housing 22, a body 24, and a baffle 26.

The temperature measuring device 20 will herein be described, for illustrative purposes only, as a dual reference (body) zone, non-contact type of measuring device utilizing the principles of heat flow exchange between a filament 28 and a pair of reference zones 30, 32 (FIG. 2) as a means to measure the temperature of the moving filament 28. As those familiar with the art will recognize, many different types of temperature measuring devices can be used to measure the temperature of a moving filament 28, any of which may be adapted to be utilized with the present disclosure.

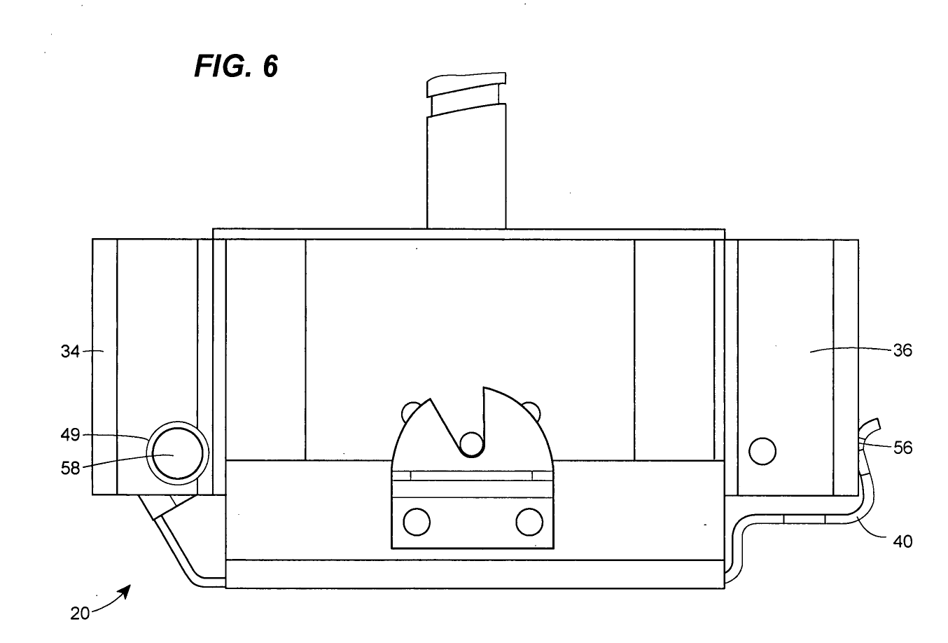

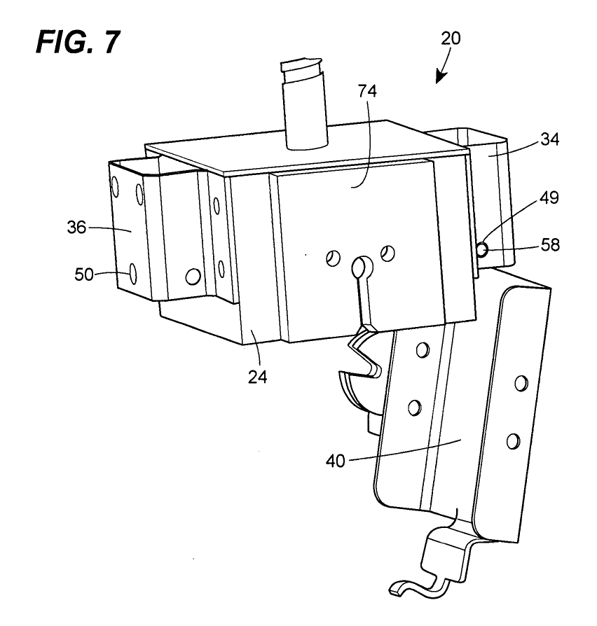

In one exemplary embodiment, as depicted in FIGS. 1, 2, 6, and 7, the housing 22 may include a first bracket 34, a second bracket 36, a frame 38 and a lid 40. The frame 38, having an upper side 42, a first side 44 and second side 46, is adapted to contain the body 24 and may be adapted to provide a mounting surface for the temperature measuring device 20. The first and second brackets 34, 36 being adapted to mount the temperature measuring device 20 and to provide a place of attachment for the lid 40, include a plurality of mounting holes 48, a pair of pivot holes 50 and a first part of a closing mechanism 52, such as a square hole. The lid 40 being adapted to provide at least a partial enclosure for the filament 28 and the body 24, includes a pair of pivot holes 49 (FIGS. 6 and 7), a knob 54 and a second part of a closing mechanism 56, such as a biased plug, that provides a spring force keeping the lid 40 closed against, for example, gravity.

In this exemplary embodiment, as seen in FIGS. 1, 2, 6, and 7, the first bracket 34 is mounted to the first side 44 of the frame 38, and the second bracket 36 is mounted to the second side 46 of the frame 38, such that the mounting holes 48 and square holes 52 on the brackets 34, 36, are located on the outer parts of the temperature measuring device 20. A pivot member 58 (FIG. 6) such as a pivot pin pivotally connects the lid 40 to one of the brackets 34, 36, and in this example, to the first bracket 34. The lid 40 is connected to the first bracket 34 by placing the pivot pin 58 through both the pivot holes 49 in the lid 40 and the pivot holes 48 in the first mounting bracket 34, thereby allowing the lid 40 to pivot about the pivot holes 49, 50 and pivot pin 58 to open and close the temperature measuring device 20. The biased plug 56 located on the lid 40 opposite the pivot holes 49, is adapted to engage with the square hole 52 located on the second bracket 36.

More specifically, when the temperature measuring device 20 is in the open position (FIGS. 1 and 7) the lid 40 will be connected to the first bracket 34 via the pivot holes 50 and the pivot pin 58, such that the lid 40 will be able to hang in a downwardly direction. In the open position, the user will have access to the body 24 and the filament 28 of the temperature measuring device 20 to enable the user to change the filament 28, clean the body 24, and/or to generally have access to the body 24 of the temperature measuring device 20. In the closed position (FIG. 6), the lid 40, while being pivotally connected to the first bracket 34, will be removably connected to the second bracket 36 by engagement of the first and second portions 52, 56 of the closing mechanism, such that the lid 40 will at least partially enclose the body 24 to protected the body 24 and/or the filament 28 from the environment. For example, when the lid 40 and the first bracket 34 are pivotally connected, the user may grasp the lid 40 by the knob 54 and rotate the lid 40 about the pivot pin 58, such that the side of the lid 40 opposite the pivot holes 49 rotates toward the second bracket 36 until the first and second portions 52, 56 of the closing mechanism engage.

The first bracket 34 and the mounting holes 48 thereon may be used to mount the temperature measuring device 20 to a machine 60 or other mounting surface. More specifically, the user, when the lid 40 is pivotally connected to the first bracket 34, may desire to mount the temperature measuring device 20 via the first bracket 34, thereby pivoting the lid 40 on the first bracket 34 and allowing the user a more direct access to the body 24 and filament 28 without having to encounter the lid 40 as an obstacle. The user may mount the temperature measuring device 20 via the mounting holes 48, for example, by fastening the first bracket 34 to the machine 60 or other mounting surface with fasteners 62, such as bolts or screws, via the mounting holes 48. It is conceivable that the user may desire to mount the temperature measuring device 20 via the second bracket 36 even though the lid 40 is pivotally connected to the first bracket 34, but the lid 40 would pivot near the front of the temperature measuring device 20 causing the user to encounter the lid 40 in order to access the body 24 and the filament 28.

The mounting scheme of the user may not be known prior to manufacture of the temperature measuring device 20. That is to say, the manufacturer may not know prior to the manufacture of the temperature measuring device 20, whether the user will mount the temperature measuring device 20 via the first bracket 34 or the second bracket 36. To enable the mounting of the temperature measuring device 20 via either the first bracket 34 or the second bracket 36, without need for any additional hardware, the brackets 34, 36 may be identical and may be mounted on the temperature measuring device 20 such that the brackets 34, 36 are mirror images of each other. By providing matching brackets 34, 36, the user may mount the temperature measuring device 20 via either the first bracket 34 or the second bracket 36, and may pivotally connect the pivot holes 49 of the lid 40 to the pivot holes 50 of either the first bracket 34 or the second bracket 36, while engaging the second part 56 of the closing mechanism on either the second bracket 36 or the first bracket 34, respectively.

In this embodiment, wherein for illustrative proposes only, the temperature measuring device 20 is a dual reference zone non-contact temperature measuring device, the body 24 includes, as depicted in FIG. 2, an inlet 64, an outlet 66, the first reference zone 30 including an upper surface 68 and a lower surface 70, the second reference zone 32 including an upper surface 68 and a lower surface 70, and a first and a second temperature flow sensor (not shown) located within or near the first and second reference zones 30, 32, respectively. The body 24 may further include an inlet spacer 72 and/or an outlet spacer 74 located adjacent the inlet 64 and the outlet 66 of the body 24, respectively.

The first reference zone 30 includes, near a first end 76, the inlet 64 of the body 24. Abutting the first reference zone 30 at a second end 78 is a first end 80 of the second references zone 32. Similarly, located near a second end 82 of the second reference zone 32 is the outlet 66 of the body 24. Located near the center of the first and second reference zones 30, 32 and extending from the inlet 64 to the outlet 66 of the body 24 is a groove 84, adapted to allow for placement of the filament 28 into a filament bore 86. The filament bore 86, located at the closed end of the groove 84 is generally located toward the middle of the upper and lower surfaces 68, 70 of the first and second reference zones 30, 32. The first and second reference zones 30, 32 may be constructed of a heat conductive material, including but not limited to, aluminum.

The inlet and outlet spacers 72, 74, as shown in FIG. 2, may be constructed of the same or similar material as the reference zones 30, 32, such as for example, if it is desired for the inlet and outlet spacers 72, 74 to conduct the heat of the reference zones 30, 32. It is also conceivable, however, that it may be desirable for the heat of the reference zones 30, 32 not be conducted to the inlet and outlet spacers 72, 74, in which case, the inlet and the outlet spacer 72, 74 may be constructed of a non-conductive material such as plastic, or the like. The groove 84 and filament bore 86 located within the reference zones 30, 32 may extend into the inlet and outlet spacers 72, 74 to allow the passing of the filament 28.

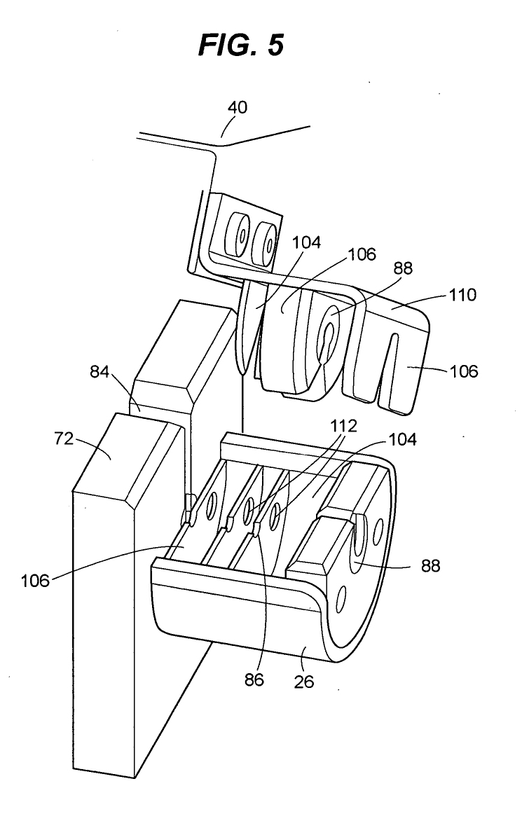

The inlet and outlet spacers 72, 74 may each contain a filament guide 88 (shown best in FIG. 5), and more specifically may each contain a filament guide 88 located in line with the filament bore 86. The filament guide 88 may be constructed from hard, non-conductive materials, such as from a ceramic, but may be constructed from any material able to achieve its intended purpose. Alternatively and/or additionally, filament guides 88 may be located in the body 24 and/or the baffle 26.

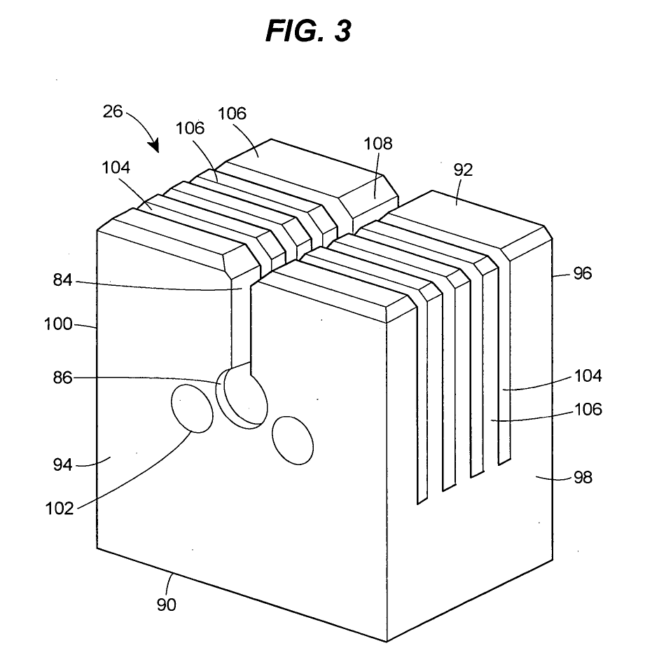

The baffle 26, as depicted in FIGS. 3, 4 and 5, includes a top 90, a bottom 92, a front side 94, a rear side 96, a first side 98, and a second side 100. The baffle 26 further includes a continuation of the groove 84, a continuation of the filament bore 86, a pair of mounting holes 102, one or more apertures 104, and one or more fins 106. The baffle 26 as depicted in FIGS. 1 and 3, may be mounted directly to the first reference zone 30 and may be constructed of similar heat conductive material as the reference zones 30, 32, such that the baffle 26 may receive and conduct heat from the first reference zone 30.

More specifically, the rear side 96 of the baffle 26 may be mounted to the first end 76 of the first reference zone 30, such that the groove 84 and filament bore 86 extent contiguously from the baffle 26 through the first and the second reference zones 30, 32 and spacers 72, 74, if applicable. The baffle 26 can be mounted in any number of ways, and may be mounted to the first reference zone 30 via a pair of fasteners (not shown) through the mounting holes 102 of the baffle 26. The one or more fins 106 and the one or more apertures 104 are located toward the bottom 92 half of the baffle 26 and may be situated perpendicular to the groove 84 and filament bore 86. More specifically, the one or more apertures 104 and the one or more fins 106 may extend from the first side 98 of the baffle 26 to the second side 100 of the baffle 26, and may only be interrupted by the groove 84 and the filament bore 86. The depth of the one or more of fins 106 and the one or more apertures 104 may be deep enough to ensure the one or more of fins 106 and the one or more apertures 104 be at least near the filament bore 86.

The baffle 26 may further include chamfers 108 located along the intersections of the groove 84 and the bottom 92 of the baffle 26 to aid in the installation of the filament 28 into the temperature sensing device 20. Conversely, the edges of the fins 106 located at the groove 84 and filament bore 86 may be sharp to enable better engagement of the fins 106 with the fluid film being dragged by the moving filament 28.

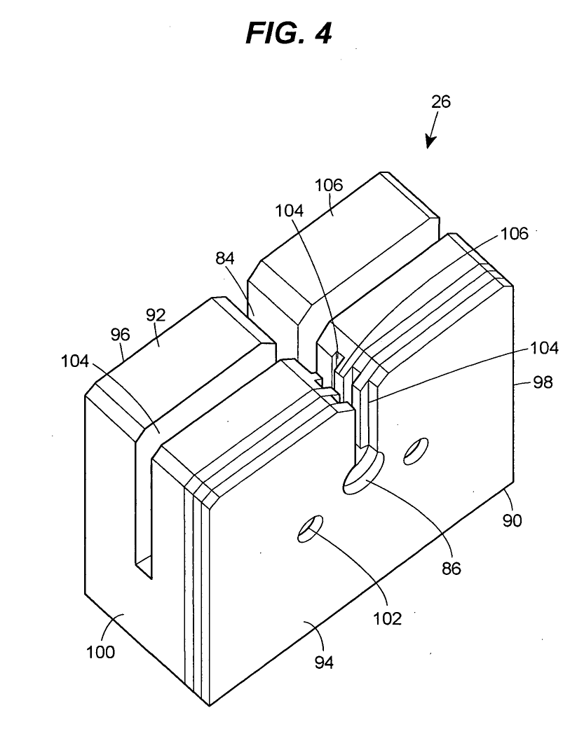

The baffle 26 may include various other configurations of fins 106 and apertures 104, as shown in another exemplary embodiment in FIG. 4. In this embodiment, not all of the fins 106 and apertures 104 extend from the first side 98 to the second side 100 of the baffle 26, but may rather be any length or depth able to accomplish the reduction of the fluid film into the temperature sensing device 20. For example, as shown in FIG. 4, the fins 106 and apertures 104 may only be fractions of an inch wide and deep, and may be staggered in a particular pattern to, once again, reduce the amount of the fluid film into the temperature sensing device 20.

In another exemplary embodiment as shown in FIG. 5, the baffle 26 may included a cover portion 110, and may include one or more additional filament guides 88. The cover portion 110 may be an attached to the lid 40, such that when the lid 40 is opened and closed, the cover portion 110 of the baffle 26 disengages and engages the baffle 26. As shown in this embodiment, the orientation of the fins 106 and apertures 104 relative to the filament bore 86 is not restricted to any particular side, but may be oriented to any and all sides of the filament bore 86. Similarly, the baffle 26 may be of any shape and size, including round, square, or any other conceivable shape.

Located on the fins 106 may be additional holes 112 or venting means to distribute the fluid flow within the baffle 26. More particularly, as shown in FIG. 5, the fins 106 may include one or more venting holes 112 that may double as mounting holes 102 (shown in FIG. 1). The venting means may further include any means of providing a flow of fluid between fins 106, including but not limited to, manufacturing the fins 106 from screen-like material.

In operation, it is desired to obtain the most accurate temperature of the filament 28 as it passes through the temperature sensing device 20. The temperature sensing device 20 may be installed and mounted according to the moving direction of the filament 28, such that the filament 28 moves from the inlet 64 of the temperature sensing device 20 toward the outlet 66 of the temperature sensing device 20. For ease of description, the operation of the temperature sensing device 20 will herein be described as if the temperature sensing device 20 is mounted via the first bracket 34, and the lid 40 is pivotally connected to the first bracket 34 via the pivot holes 49, 50 and pivot pin 58.

In one exemplary embodiment, as depicted in FIGS. 1, 2 and 7, the user may insert the filament 28 into the filament bore 86, by first opening and disengaging the second portion 56 of the closing mechanism from the first portion 52 of the closing mechanism, thereby opening the lid 40 and allowing for the insertion the filament 28 into the filament bore 86 through the groove 84. Once the filament 28 is located within the filament bore 86, the user may close the lid 40 by rotating the lid 40 by the knob 54 toward the second bracket 36, eventually engaging the first and second portions 52, 56 of the closing mechanism. Prior to moving and measuring the temperature of the filament 28, the user may properly prepare the temperature sensing device 20 for use such as calibrating, powering-up or warming-up the temperature sensing device 20.

Once the filament 28 begins to move the temperature sensing device 20 may begin to measure the temperature of the moving filament 28. The temperature of the filament 28 may be any temperature, but most often is in the range from about 50° F. to about 525° F. and may be any speed, but once again is most often in the range from about 60 meters per minute to about 4000 meters per minute. This discloser is, however, not limited to the value ranges of temperature and speed identified above, but as those skilled in the art will recognize, may include both temperatures and speeds above and below the ranges identified.

Once the filament 28 is moving, especially at higher speeds, the filament 28 may flutter thereby creating a wave-like or up-and-down motion in the filament 28. This fluttering phenomenon may cause the moving filament 28, which may be at temperatures upwards of 525° F., to contact or brush against various portions of the temperature sensing device 20. To prevent damage to either the filament 28 and/or the temperature sensing device 20, one or more filament guides 88 may be strategically located along the filament bore 86 to buffer contact between the fast moving heated filament 28 and the temperature sensing device 20. For example, as seen in FIGS. 1, 2, 4, and 5 filament guides 88 may be located in the baffle 26, the spacers 72, 74 and/or the reference zones 30, 32.

As the filament 28 moves through the fluid, in this example air, an air film is created a round the filament 28 causing the moving filament 28 to drag unwanted air into the temperature sensing device 20, thereby affecting the accuracy of the temperature measurement of the filament 28. The baffle 26, located prior to the body 24 of the temperature sensing device 20 may reduce the amount of the air film that is dragged into the temperature sensing device 20, by forcing the air film to pass one or more fins 106 and apertures 104. More specifically, as the filament 28 moves through the baffle 26, the one or more fins 106 and apertures 104 may change the aerodynamics of the air film around the filament 28. The one or more fins 106 and apertures 104 may, for example, create a turbulent airflow around the filament 28 by the passage of the air film past the one or more fins 106 and apertures 104, thereby reducing the amount of air film that enters the body 24 of the temperature sensing device 20, and ultimately reducing the inaccuracy of the temperature measurement of the filament 28.

Additionally or alternatively, to reduce the amount of air film that enters the body 24 of the temperature sensing device 20, the baffle 26 may be heated to preheat the air entering the temperature sensing device 20, to reduce the inaccuracies of the temperature measurement of the filament 28 caused by the entering air. For example, because the temperature measurement of the filament 28 may be accomplished by the relative difference of the filament 28 to the reference zone 30, any air that enters into the filament bore 86 that is not at the temperature of the reference zone 30 or filament 28, may reduce the accuracy of the temperature measurement of the filament 28. By heating or preheating the air prior to entering the temperature sensing device 20, the air that does eventually enter may be at a closer temperature to either the filament 28 or the reference zone 30, thereby making the temperature reading of the filament 28 more accurate.

The baffle 26 may be heated in any number of ways, and may be heated by the first reference zone 30. More specifically, the baffle 26 may be mounted to the first reference zone 30 either directly or indirectly. If mounted directly, such as in FIG. 1, the baffle 26 need only be constructed of heat conducting material, thereby conducting heat from the first reference zone 30 to the baffle 26. If mounted indirectly to the first reference zone 30, such as in FIG. 2, wherein the inlet spacer 72 separates the baffle 26 and the first reference zone 30, the inlet spacer 72 and the baffle 26 can be constructed of heat conducting material, thereby conducting heat from the first reference zone 30, to the inlet spacer 72 and then to the baffle 26.

The preheating of the air entering the temperature sensing device 20 may further be aided by proper positioning and orientation of the baffle 26. More specifically, as is known in the art, warm air rises and cooler air settles, and as seen in FIGS. 1 and 5, the filament bore 86 has an enclosure located above it. For example, in FIG. 1 the apertures 104 of the baffle 26 only open to the bottom 92 and the first and second sides 98, 100 of the baffle 26, thereby preventing a substantial amount of heated air from escaping in an upward direction from the baffle 26. By preventing the heated air from escaping in an upward directing, the filament bore 86 can entrap heated air in the filament bore 86. Similarly, as seen in FIG. 5, the apertures 104 of the baffle 26 are enclosed by the cover portion 110 of the baffle 26, thereby preventing heated air from escaping in an upward direction.

The foregoing detailed description has been given for clearness of understanding only and no unnecessary limitations should be understood therefrom, as modifications may be obvious to those skilled in the art.

What is claimed is:

1. A temperature measuring device for measuring the temperature of a moving filament, comprising:
a body having an inlet and an outlet for entry and exit of the moving filament; and
a baffle preceding the inlet, the baffle including at least one fin and at least one aperture adapted to reduce a fluid film associated with the moving filament.

2. The temperature measuring device of claim 1, further including a bore disposed between the inlet and the outlet of the baffle for receiving the moving filament.

3. The temperature measuring device of claim 1, further including a groove disposed in the baffle for inserting and removing the filament from the baffle.

4. The temperature measuring device of claim 1, further including a guide disposed in the baffle for guiding the moving filament.

5. The temperature measuring device of claim 4, wherein the guide is disposed along a bore in the baffle.

6. The temperature measuring device of claim 1, wherein the baffle is mounted on the body near the inlet of the body.

7. The temperature measuring device of claim 1, wherein the at least one aperture provides a pathway to an exterior of the baffle.

8. The temperature measuring device of claim 1, wherein the at least one aperture is an area disposed between a first fin and a second fin.

9. The temperature measuring device of claim 1, wherein the baffle includes a first portion that is moveable relative to a second portion.

10. The temperature measuring device of claim 9, wherein the second portion of the baffle includes a lid that at least partially encloses the filament in the baffle.

11. The temperature measuring device of claim 9, wherein the first and the second portions of the baffle each include at least one fin and at least one aperture.

12. The temperature measuring device of claim 1, wherein the baffle is heated, thereby preheating air that may enter the body of the temperature measuring device.

13. The temperature measuring device of claim 1, wherein the at least one aperture in the baffle does not open to a top of the baffle.

14. A baffle for use with a temperature measuring device for measuring the temperature of a moving filament, comprising:
an inlet and an outlet for entry and exit of the moving filament;
a bore disposed between the inlet and the outlet for receiving the moving filament;
at least one fin disposed along the bore, wherein the at least one fin is oriented generally perpendicular to the bore; and
at least one aperture disposed along the bore, wherein the at least one aperture is oriented generally perpendicular to the bore.

15. The baffle of claim 14, further including a groove disposed along the bore for inserting and removing the filament from the baffle.

16. The baffle of claim 14, further including a guide disposed near the bore for guiding the moving filament.

17. The baffle of claim 14, wherein the baffle is mounted to a temperature measuring device.

18. The baffle of claim 14, wherein the at least one aperture provides a pathway to an exterior of the baffle.

19. The baffle of claim 14, wherein the at least one aperture is an area disposed between a first fin and a second fin.

20. The baffle of claim 14, wherein the baffle includes a first portion that is moveable relative to a second portion.

21. The baffle of claim 20, wherein the second portion includes a lid that at least partially encloses the filament in the baffle.

22. The baffle of claim 20, wherein the first and the second portions of the baffle each include at least one fin and at least one aperture.

23. The baffle of claim 14, wherein the baffle is heated, thereby preheating air that may enter the body of the temperature measuring device.

24. The baffle of claim 14, wherein the at least one aperture in the baffle does not open to a top of the baffle.

25. A method of measuring the temperature of a moving filament, comprising:
moving the filament through a baffle having at least one fin and at least one aperture;
reducing a fluid film associated with the moving filament;
moving the filament through a temperature measuring device having a body including an inlet and an outlet for entry and exit of the moving filament; and
measuring the temperature of the moving filament with the temperature measuring device.

26. The method of measuring the temperature of a moving filament of claim 25, further including guiding the filament with a filament guide.

27. The method of measuring the temperature of a moving filament of claim 25, further including moving a first portion of the baffle relative to a second portion of the baffle, thereby at least partially enclosing the filament in the baffle.

28. The method of measuring the temperature of a moving filament of claim 25, further including inserting the filament into the baffle.

29. The method of measuring the temperature of a moving filament of claim 25, further including heating the baffle.
